(19) United States
(12) Patent Application Publication
(10) Pub. No.: US 2018/0293088 A1
(43) Pub. Date: Oct. 11, 2018

(54) INTERACTIVE COMMENT INTERACTION METHOD AND APPARATUS

(71) Applicant: TENCENT TECHNOLOGY (SHENZHEN) COMPANY LIMITED, Shenzhen, Guangdong (CN)

(72) Inventors: Cong CHEN, Shenzhen (CN); Zhijun CAI, Shenzhen (CN); Liwei ZHAO, Shenzhen (CN); Fangjun XIE, Shenzhen (CN)

(73) Assignee: TENCENT TECHNOLOGY (SHENZHEN) COMPANY LIMITED, Shenzhen, Guangdong (CN)

(21) Appl. No.: 15/765,153

(22) PCT Filed: Jan. 24, 2017
(86) PCT No.: PCT/CN2017/072315

§ 371 Date: Mar. 30, 2018

(30) Foreign Application Priority Data
Feb. 2, 2016 (CN) 201610074906.7

(51) Int. Cl. G06F 9/451; G06F 3/0485

(52) U.S. Cl. CPC G06F 9/451; G06F 3/0485

(57) ABSTRACT

An interactive comment interface method and apparatus are provided that allow a user to obtain a comment publishing request in a text input interface, a picture input interface, a music input interface, a speech input interface, and/or a video input interface. The interface also allows for one or more combinations of text, picture, speech, and video that can be provided by using the data input interface that creates rich-media comment information.

### CROSS-REFERENCE TO RELATED APPLICATION

This application is a U.S. national stage application under 35 U.S.C. § 371 of International Application No. PCT/CN2017/072315, filed on Jan. 22, 2017, in the Chinese Patent Office, which claims priority from Chinese Patent Application No. 201610074906.7, entitled “INTERACTIVE COMMENT INTERACTION METHOD AND APPARATUS,” filed on—Jan. 29, 2016, in the Chinese Patent Office, the disclosures of which is incorporated by reference in their entireties.

### BACKGROUND

### 1. Field

Methods and apparatuses consistent with example embodiments related to Internet technologies, and in particular, to an interactive comment interaction method and apparatus.

### 2. Description of Related Art

With development of mobile network technologies and rise of mobile social applications, a user may publish information anytime and anywhere, and the user's contacts may make an interactive comment on the information published by the user, thereby increasing interaction and interchangeability between users. However, in a conventional social application, when users make interactive comments between each other, interaction can be usually performed only in a text form. As shown in FIG. 1, in Wechat moments, interactive comments between users can be made only by means of text presentation, but a single text interaction manner is relatively monotonous and uninteresting.

### SUMMARY

To overcome the monotonous and uninteresting interactions when using a conventional interactive comment, one or more exemplary embodiment provides an interactive comment interaction method and apparatus that enhances the interaction between users.

According to example embodiments, there is provided an interactive comment interaction method, the method including obtaining a comment publishing request on an interactive comment interface; providing a data input interface according to the comment publishing request, the data input interface including a text input interface, a picture input interface, a music input interface, a speech input interface, and a video input interface; obtaining one or more combinations of text, a picture, a speech, and a video that are input by using the data input interface, to form rich-media comment information; obtaining a submission request for the rich-media comment information; and submitting the rich-media comment information according to the submission request.

According to example embodiments, there is provided an interactive comment interaction apparatus, the apparatus including at least a processor and a memory, the memory storing a publishing request obtaining module, an interface providing module, a data obtaining module, a submission request obtaining module, and a submission module, and when being executed by the processor, the publishing request obtaining module being configured to obtain a comment publishing request on an interactive comment interface; the interface providing module being configured to provide a data input interface according to the comment publishing request, the data input interface including a text input interface, a picture input interface, a music input interface, a speech input interface, and a video input interface; the data obtaining module being configured to obtain one or more combinations of text, a picture, a speech, and a video that are input by using the data input interface, to form rich-media comment information; the submission request obtaining module being configured to obtain a submission request for the rich-media comment information; and the submission module being configured to submit the rich-media comment information according to the submission request.

According to example embodiments, there is provided a non-volatile computer storage medium stores a computer program, the computer program being configured to perform the foregoing interactive comment interaction method.

### BRIEF DESCRIPTION OF THE DRAWINGS

FIG. 1 is a schematic diagram showing that only text can be input into an interactive comment.

FIG. 2 is a schematic diagram of an internal structure of a terminal according to example embodiments.

FIG. 3 is a flowchart of an interactive comment interaction method according to example embodiments.

FIG. 4 is a schematic diagram of providing a data input interface on an interactive comment interface according to example embodiments.

FIG. 5A is a schematic diagram of inputting music on an interactive comment interface according to example embodiments.

FIG. 5B is a schematic diagram of recording a speech on an interactive comment interface according to example embodiments.

FIG. 5C is a schematic diagram of inputting a picture on an interactive comment interface according to example embodiments;

FIG. 5D is a schematic diagram of inputting a video on an interactive comment interface according to example embodiments.

FIG. 6 is a flowchart of an interactive comment interaction method according to example embodiments.

FIG. 7 is a schematic diagram of presenting rich-media comment information in a text link form on an interactive comment interface according to example embodiments.

FIG. 8 is a schematic diagram of presenting rich-media comment information and a button on an interactive comment interface according to example embodiments.

FIG. 9A is a schematic diagram of presenting a speech file in a floating layer according to example embodiments.

FIG. 9B is a schematic diagram of presenting a music file in a floating layer according to example embodiments.

FIG. 9C is a schematic diagram of presenting a video file in a floating layer according to example embodiments.

FIG. 10 is a structural block diagram of an interactive comment interaction apparatus according to example embodiments.

FIG. 11 is a structural block diagram of an interactive comment interaction apparatus according to example embodiments.

FIG. 12 is a structural block diagram of an interactive comment interaction apparatus according to example embodiments.

FIG. 13 is a structural block diagram of an interactive comment interaction apparatus according to example embodiments.

FIG. 14 is a structural block diagram of hardware of an interactive comment interaction apparatus according to example embodiments.

### DESCRIPTION OF EXAMPLE EMBODIMENTS

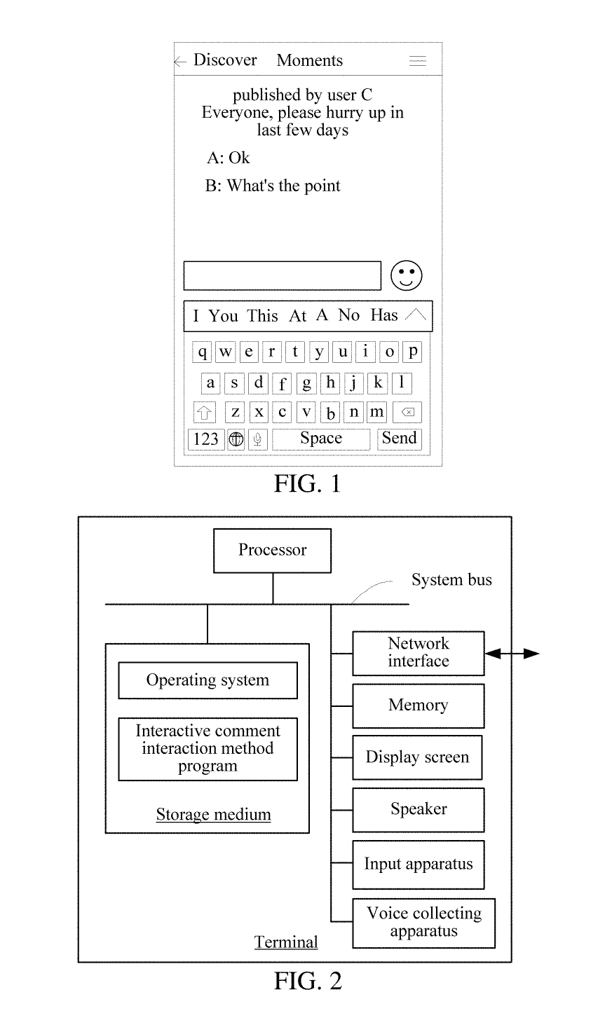

FIG. 1 is a schematic diagram showing that only text can be input into an interactive comment. As shown in FIG. 1, after user C in Wechat moments publishes information, other users (such as user A and/or user B) can only respond by inserting a single text if those other users intend to make a comment on the published information. The single text interaction manner is relatively monotonous and uninteresting.

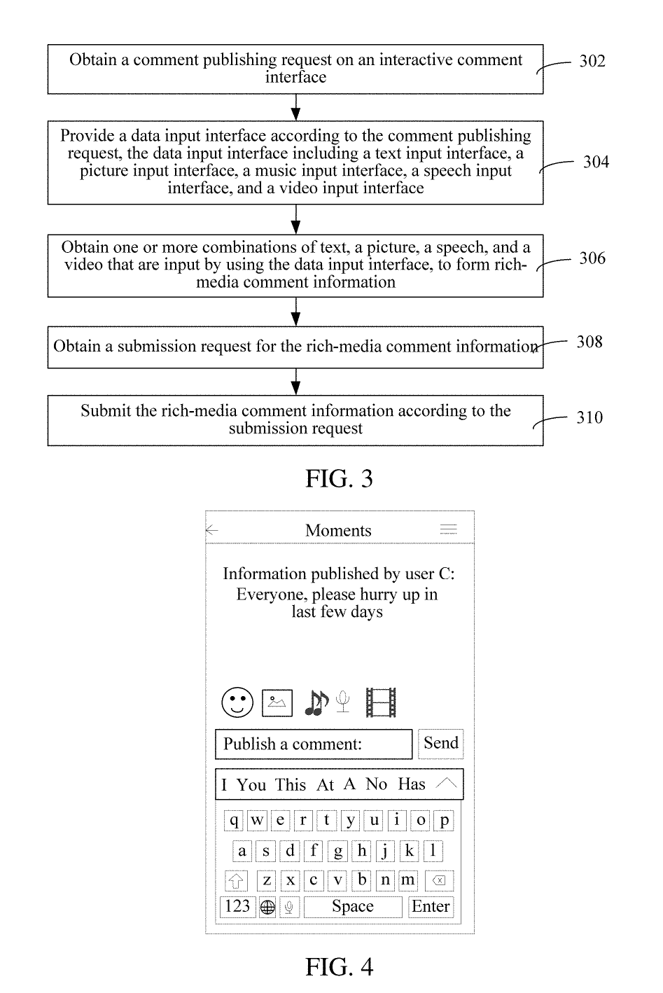

FIG. 2 is a schematic diagram of an internal structure of a terminal according to example embodiments. As shown in FIG. 2, the terminal includes a processor, a storage medium, a memory, a network interface, a voice collecting apparatus, a display screen, a speaker, and an input device that are connected by using a system bus. The storage medium of the terminal stores an operating system, and further includes a program for implementing an interactive comment interaction method, and the program is configured to implement an interactive comment interaction method. The processor is used to provide a calculating and control capability, and supports running of the entire terminal. The memory in the terminal provides an environment for running of the foregoing program in the storage medium, and the network interface is configured to perform network communication with a server, for example, send comment information to the server, or receive other comment information returned by the server. The display screen of the terminal may include, but is not limited to, a crystal liquid display screen or an electronic ink display screen, and the input device may include, but is not limited to, a touch layer covering the display screen, a key, a track ball, a touchpad disposed on a terminal housing, an external keyboard, touchpad, or mouse. The terminal may include, but is not limited to, a mobile terminal such as a mobile phone, a notebook computer, a tablet computer, a personal digital assistant, a wearable device or a vehicle-mounted computer. Persons skilled in the art may understand that, the structure shown in FIG. 2 is a block diagram of a partial structure related to this application solution, and does not constitute any limitation to a terminal to which this application solution is applied. Specifically, the terminal may include more or fewer parts than those shown in the figure, or some parts are combined, or different part deployment is performed.

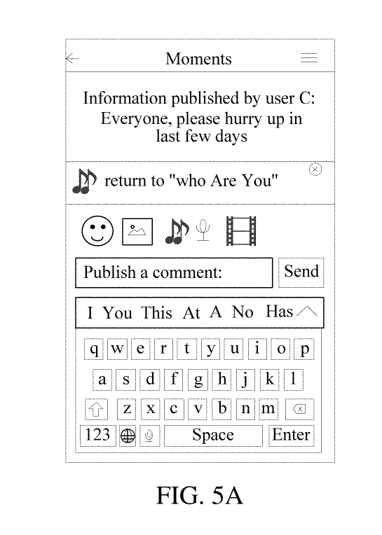

FIG. 3 is a flowchart of an interactive comment interaction method according to an embodiment. As shown in FIG. 3, the interactive comment interaction method is run on the terminal in FIG. 2.

In Step 302, obtaining a comment publishing request on an interactive comment interface.

In these example embodiments, a user logs in to a social application in the terminal by using a user identifier, and browses information published by another user in the social application. When the user needs to make a comment on the information published by the another user, the user enters the interactive comment interface, and obtains the comment publishing request of the user for the information published by the another user.

The social application may include, but is not limited to, an instant messaging application, a social networking service (SNS) application, a post bar application, Instagram, or the like. The instant messaging application include, but is not limited to, Wechat moments, QQ space, MSN, and the like. The SNS application may include, but is not limited to, Renren, Facebook, and the like, but this application is not limited to this.

In Step 304, providing a data input interface according to the comment publishing request, the data input interface including a text input interface, a picture input interface, a music input interface, a speech input interface, and a video input interface.

In these example embodiments, the data input interface is an entry supporting a corresponding type of data input. A corresponding type of data input may be performed by clicking the data input interface. For example, when the text input interface is triggered, a keyboard may be started to perform text input. When the picture input interface is triggered, an album may be entered to select picture input or a camera may be started to perform shooting, and a taken picture is used as comment information. When the music input interface is triggered, a local music database or network music database may be entered to select music to be used as comment information. The local music database stores downloaded music and/or self-made music or the like. The network music database stores network music. The network music database may include, but it is not limited to, a web disk, cloud, or the like. When the speech input interface is triggered, a speech begins to be recorded. When the video input interface is triggered, a video or the like may be selected from a local video database or a network video database. The local video database may store a downloaded video and/or a self-made video or the like. Moreover, the data input interface may further include an emoticon input interface and the like.

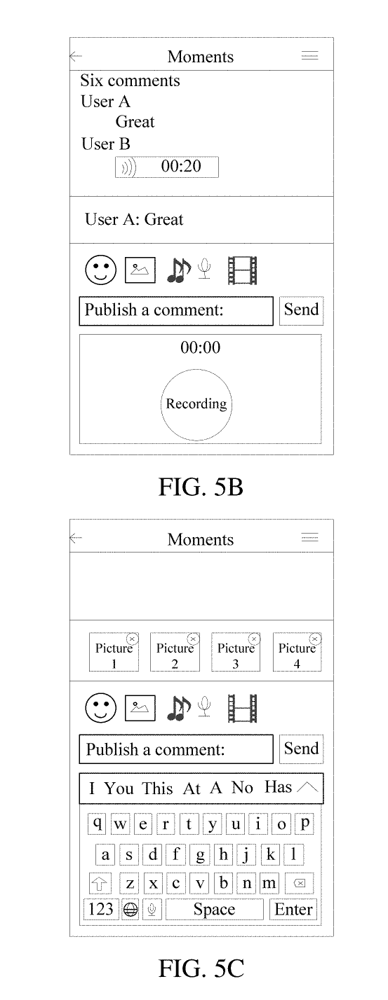

As shown in FIG. 4, a text input interface, an emoticon input interface, a picture input interface, a music input interface, a speech input interface, a video input interface, and the like are provided in the interactive comment interface. A corresponding data input interface is selected to input corresponding data.

In Step 306, obtaining one or more combinations of text, a picture, a speech, and a video that are input by using the data input interface, to form rich-media comment information.

In these example embodiments, one or more data combinations of text, a picture, a speech, and a video that are input by the user by using the data input interface are obtained, to form rich-media comment information. The rich-media comment information may include one or more types of data such as text, a voice, a picture, and a video.

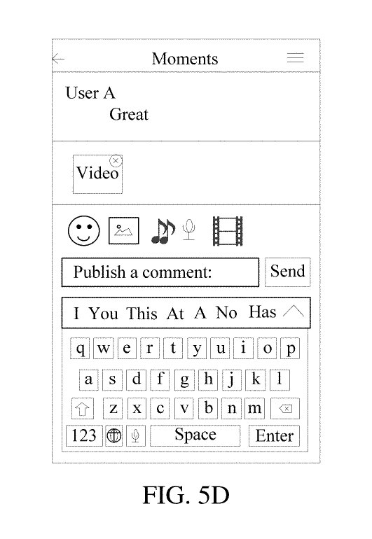

As shown in FIG. 5A, a trigger operation for a music input interface is obtained in an interactive comment interface, and selection is performed to input a song, for example, return to a song “who Are You”.

As shown in FIG. 5B, a trigger operation for a speech input interface is obtained in an interactive comment interface, recording is displayed, and speech recording is performed.

As shown in FIG. 5C, a trigger operation for a picture input interface is obtained in an interactive comment interface, one or more pictures may be selected after an album is entered, and the one or more pictures are used as comment information.

As shown in FIG. 5D, a trigger operation for a video input interface is obtained in an interactive comment interface, a local video database is entered to select a needed video file, and the video file is used as comment information or as part of comment information.

In Step 308, obtaining a submission request for the rich-media comment information.

In these embodiments, the submission request for the rich-media comment information is obtained on the interactive comment interface, and the rich-media comment information is submitted according to the submission request.

In Step 310, submitting the rich-media comment information according to the submission request.

According to the foregoing interactive comment interaction method, the data input interface is provided on the interactive comment interface, and it is convenient for a user to input data including, but is not limited to, text, a picture, music, a speech, a video, and the like by using the data input interface, so as to form the rich-media comment information. Therefore, users may make interactive comments in a representation form such as text, a picture, music, a speech, or a video, so as to add an interaction manner of performing interaction between the users, and enrich user experience.

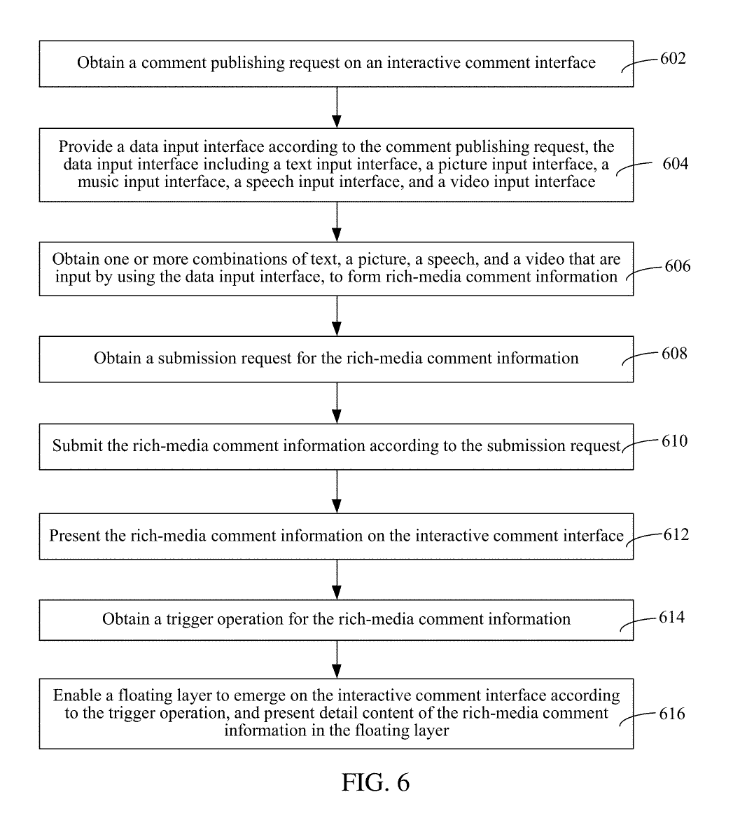

FIG. 6 is a flowchart of an interactive comment interaction method according to the example embodiments. In Step 602, obtaining a comment publishing request on an interactive comment interface.

In these example embodiments, a user logs in to a social application in the terminal by using a user identifier, and browses information published by another user in the social application. When the user needs to make a comment on the information published by the another user, the user enters the interactive comment interface, and obtains the comment publishing request of the user for the information published by the another user.

In Step 604, a data input interface according to the comment publishing request, the data input interface including a text input interface, a picture input interface, a music input interface, a speech input interface, and a video input interface.

In these embodiments, the data input interface is an entry supporting a corresponding type of data input. A corresponding type of data input may be performed by clicking the data input interface. For example, when the text input interface is triggered, a keyboard may be started to perform text input. When the picture input interface is triggered, an album may be entered to select picture input or a camera may be started to perform shooting, and a taken picture is used as comment information. When the music input interface is triggered, a local music database or network music database may be entered to select music to be used as comment information. The local music database stores downloaded music and/or self-made music or the like. The network music database stores network music. The network music database may include, but is not limited to, in a form of a web disk, cloud, or the like. When the speech input interface is triggered, a speech begins to be recorded. When the video input interface is triggered, a video or the like may be selected from a local video database or a network video database. The local video database may store a downloaded video and/or a self-made video or the like. Moreover, the data input interface may further include an emoticon input interface and the like.

In Step 606, obtaining one or more combinations of text, a picture, a speech, and a video that are input by using the data input interface, to form rich-media comment information.

In these example embodiments, one or more data combinations of text, a picture, a speech, and a video that are input by the user by using the data input interface are obtained, to form rich-media comment information. The rich-media comment information may include one or more types of data such as text, a voice, a picture, and a video.

In Step 608, obtaining a submission request for the rich-media comment information.

In these example embodiments, the submission request for the rich-media comment information is obtained on the interactive comment interface, and the rich-media comment information is submitted according to the submission request.

In Step 610, submitting the rich-media comment information according to the submission request.

In Step 612, presenting the rich-media comment information on the interactive comment interface.

In Step 614, obtaining a trigger operation for the rich-media comment information.

In Step 616, enabling a floating layer to emerge on the interactive comment interface according to the trigger operation, and present detail content of the rich-media comment information in the floating layer.

The floating layer is a suspending window. In the floating layer, texts and pictures are displayed, music playing, speech playing, video playing, and the like may be performed. Further, a slide operation may be performed to move displayed content.

According to the foregoing interactive comment interaction method, the data input interface is provided on the interactive comment interface, and it is convenient for a user to input data including text, a picture, music, a speech, a video, and the like by using the data input interface, so as to form the rich-media comment information. Therefore, users may make interactive comments in a representation form such as text, a picture, music, a speech, or a video, so as to add an interaction manner of performing interaction between the users, and enrich user experience. Moreover, the rich-media comment information is presented on the interactive comment interface, and after a trigger operation is performed on a rich-media comment, the floating layer is enabled to emerge on the interactive comment interface, and the detail content of the rich-media comment information is presented in the floating layer. All interactive comment information does not need to be presented in a content stream, so as to reduce presentation space, and the detail content does not need to be viewed in a page skipping manner. Therefore, it is more convenient to view the detail content by using the floating layer.

The step of presenting the rich-media comment information on the interactive comment interface includes: presenting, on the interactive comment interface, the rich-media comment information carrying a detail content viewing control. The control may include, but is not limited to, a text link, an icon, a button, or the like.

In these example embodiments, the step of presenting, on the interactive comment interface, the rich-media comment information carrying a detail content viewing control includes: presenting the rich-media comment information in a text link form on the interactive comment interface.

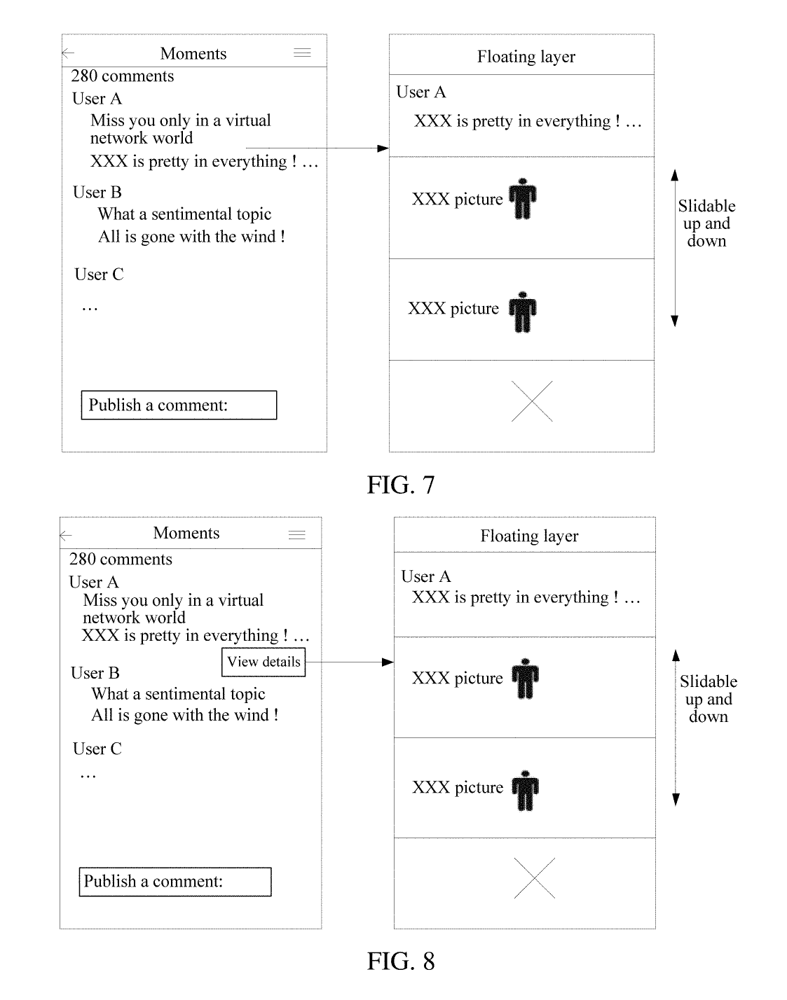

As shown in FIG. 7, the rich-media comment information is presented in a text link form on an interactive comment interface. For example, for “miss you only in a virtual network world” published by a user A, a detail content digest is: XXX is pretty in everything! For “what a sentimental topic” published by a user B, a detail content digest is: all is gone with the wind! After the detail content digest published by the user A is clicked, a floating layer emerges, and detail content of rich-media comment information is presented in the floating layer, and includes text “XXX is pretty in everything!” and picture content. When all content of the rich-media comment information cannot be displayed on one screen in the floating layer, the user can slide the screen up and down, to view all the rich-media comment information.

In these example embodiments, the step of presenting, on the interactive comment interface, the rich-media comment information carrying a detail content viewing control includes presenting the rich-media comment information and a detail content viewing icon or button on the interactive comment interface.

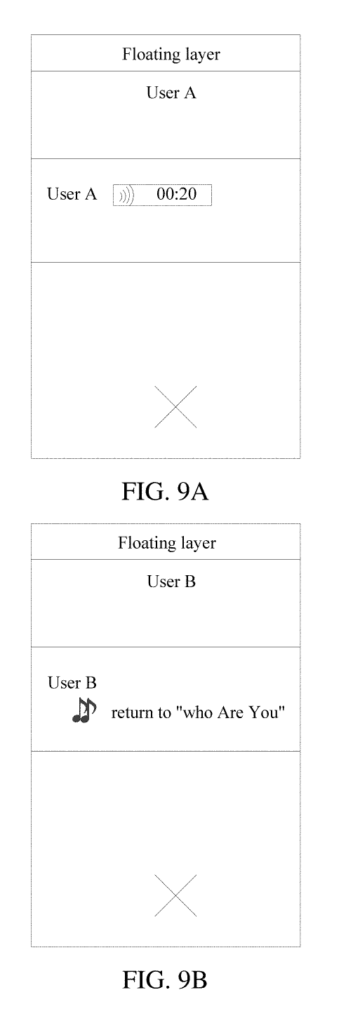

As shown in FIG. 8, at the same time when rich-media comment information is presented on an interactive comment interface, a button that enables the user to view the contents of the rich-media comments information is presented. When the user clicks on the button is, a floating layer emerges, and the content of the rich-media comment information is presented in the floating layer including text such as “XXX is pretty in everything!” and picture content. When all content of the rich-media comment information cannot be displayed on one screen in the floating layer, the user can slide the screen up and down to view the rich-media comment information.

Further, the foregoing interactive comment interaction method further includes obtaining a slide operation direction for the detail content of the rich-media comment information in the floating layer after the step of enabling the floating layer to emerge on the interactive comment interface according to the trigger operation and presenting the detail content of the rich-media comment information in the floating layer; and correspondingly moving the detail content of the rich-media comment information according to the slide operation direction.

In these example embodiments, when the slide operation direction is a first direction, the detail content of the rich-media comment information is moved toward the first direction; or when the slide operation direction is a second direction, the detail content of the rich-media comment information is moved toward the second direction. Using a mobile phone terminal as an example, the detail content of the rich-media comment information is presented in a portrait mode on a screen of the mobile phone, and if the slide operation direction is upward, the detail content of the rich-media comment information is moved upward; or if the slide operation direction is downward, the detail content of the rich-media comment information is moved downward.

Further, the foregoing interactive comment interaction method further includes obtaining a slide operation speed, and determining, according to the slide operation speed, a distance by which the detail content of the rich-media comment information is moved.

In these example embodiments, a slide operation distance and a slide operation time are obtained, and the slide operation speed is obtained through calculation according to the slide operation distance and the slide operation time. A mapping relationship between the slide operation speed and the distance by which the detail content is moved is obtained by collecting statistics. The movement distance is obtained according to the slide operation speed from the mapping relationship between the slide operation speed and the distance by which the detail content is moved.

In these example embodiments, a distance between two last points of a track formed by a slide operation and a consumed time are obtained, and a slide operation speed is obtained through calculation.

Further, the rich-media comment information includes one or more combinations of a speech, music, and a video; and the foregoing interactive comment interaction method further includes: obtaining a playing instruction; and playing the one or more combinations of the speech, the music, and the video according to the playing instruction.

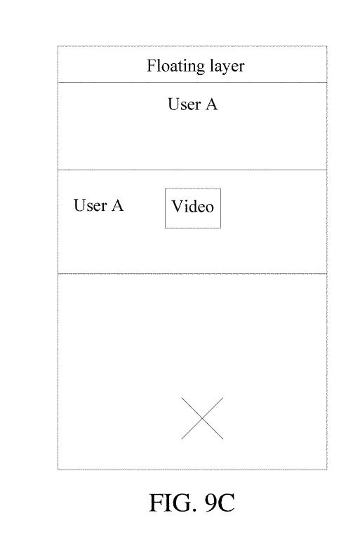

As shown in FIG. 9A, a speech file is presented in a floating layer, a click operation for the speech file is obtained, and the speech file is played.

As shown in FIG. 9B, a music file is presented in a floating layer, a click operation for the music file is obtained, and the music file is played.

As shown in FIG. 9C, a video file is presented in a floating layer, a click operation for the video file is obtained, and the video file is played.

In example embodiments, the foregoing interactive comment interaction method further includes obtaining a publishing time of the rich-media comment information, and sorting the rich-media comment information according to the publishing time. The most recently published rich-media comment information may be ranked at the top or at the bottom. A process of the interactive comment interaction method is described below with reference to example embodiments. For example, the interactive comment interaction method is applied to Wechat moments, and the method includes a comment publishing request is obtained on an interactive comment interface of Wechat moments; a data input interface is provided on the interactive comment interface according to the comment publishing request, the data input interface including a text input interface, a picture input interface, a music input interface, a speech input interface, and a video input interface; one or more combinations of text, a picture, a speech, and a video that are input by using the data input interface are obtained, to form rich-media comment information; a submission request for the rich-media comment information is obtained; the rich-media comment information is submitted according to the submission request; the rich-media comment information is presented on the interactive comment interface of the Wechat moments; a click operation for the rich-media comment information is obtained; a floating layer is enabled to emerge on the interactive comment interface according to the click operation, and detail content of the rich-media comment information is presented in the floating layer.

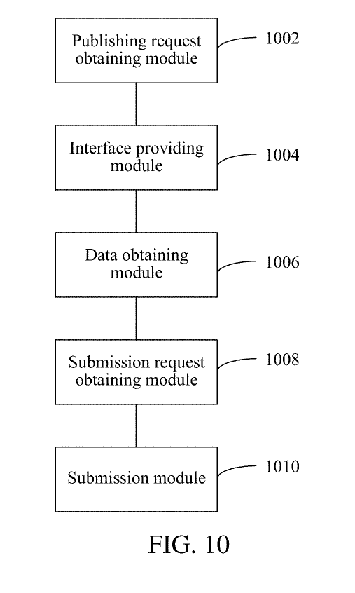

Interactive comment interaction apparatuses shown in FIG. 10 to FIG. 14 may be run on the mobile terminal shown in FIG. 2. The mobile terminal shown in FIG. 2 may include, but is not limited to, a mobile terminal such as a mobile phone, a notebook computer, a tablet computer, a personal digital assistant, a wearable device or a vehicle-mounted computer.

FIG. 10 is a structural block diagram of an interactive comment interaction apparatus according to an embodiment. As shown in FIG. 10, the interactive comment interaction apparatus includes a publishing request obtaining module 1002, an interface providing module 1004, a data obtaining module 1006, a submission request obtaining module 1008, and a submission module 1010.

The publishing request obtaining module 1002 is configured to obtain a comment publishing request on an interactive comment interface.

In this embodiment, a user logs in to a social application in the terminal by using a user identifier, and browses information published by another user in the social application. When the user needs to make a comment on the information published by the another user, the user enters the interactive comment interface, and obtains the comment publishing request of the user for the information published by the another user.

The social application may be an instant messaging application, an SNS application, a post bar application, Instagram, or the like. The instant messaging application may include Wechat moments, QQ space, MSN, and the like. The SNS application may include, but is not limited to, Renren, Facebook, and the like.

The interface providing module 1004 is configured to provide a data input interface according to the comment publishing request, the data input interface including a text input interface, a picture input interface, a music input interface, a speech input interface, and a video input interface.

In these example embodiments, the data input interface is an entry supporting a corresponding type of data input. A corresponding type of data input may be performed by clicking the data input interface. For example, when the text input interface is triggered, a keyboard may be started to perform text input. When the picture input interface is triggered, an album may be entered to select picture input or a camera may be started to perform shooting, and a taken picture is used as comment information. When the music input interface is triggered, a local music database or network music database may be entered to select music to be used as comment information. The local music database stores downloaded music and/or self-made music or the like. The network music database stores network music. The network music database may be in a form of a web disk, cloud, or the like. When the speech input interface is triggered, a speech begins to be recorded. When the video input interface is triggered, a video or the like may be selected from a local video database or a network video database. The local video database may store a downloaded video and/or a self-made video or the like. Moreover, the data input interface may further include an emoticon input interface and the like.

The data obtaining module 1006 is configured to obtain one or more combinations of text, a picture, a speech, and a video that are input by using the data input interface, to form rich-media comment information.

In these example embodiments, one or more data combinations of text, a picture, a speech, and a video that are input by the user by using the data input interface are obtained, to form rich-media comment information. The rich-media comment information may include one or more types of data such as text, a voice, a picture, and a video.

The submission request obtaining module 1008 is configured to obtain a submission request for the rich-media comment information.

The submission module 1010 is configured to submit the rich-media comment information according to the submission request.

According to the foregoing interactive comment interaction apparatus, the data input interface is provided on the interactive comment interface, and it is convenient for a user to input data including text, a picture, music, a speech, a video, and the like by using the data input interface, so as to form the rich-media comment information. Therefore, users may make interactive comments in a representation form such as text, a picture, music, a speech, or a video, so as to add an interaction manner of performing interaction between the users, and enrich user experience.

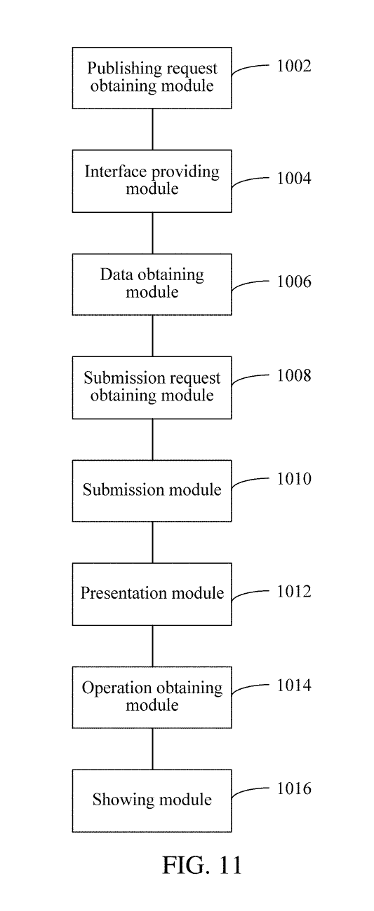

FIG. 11 is a structural block diagram of an interactive comment interaction apparatus according to another embodiment. As shown in FIG. 11, in addition to a publishing request obtaining module 1002, an interface providing module 1004, a data obtaining module 1006, a submission request obtaining module 1008, and a submission module 1010, the interactive comment interaction apparatus further includes a presentation module 1012, an operation obtaining module 1014, and a showing module 1016.

The presentation module 1012 is configured to present the rich-media comment information on the interactive comment interface after the rich-media comment information is submitted according to the submission request.

The operation obtaining module 1014 is configured to obtain a trigger operation for the rich-media comment information.

The showing module 1016 is configured to enable a floating layer to emerge on the interactive comment interface according to the trigger operation, and present detail content of the rich-media comment information in the floating layer.

According to the foregoing interactive comment interaction apparatus, the data input interface is provided on the interactive comment interface, and it is convenient for a user to input data including text, a picture, music, a speech, a video, and the like by using the data input interface, so as to form the rich-media comment information. Therefore, users may make interactive comments in a representation form such as text, a picture, music, a speech, or a video, so as to add an interaction manner of performing interaction between the users, and enrich user experience. Moreover, the rich-media comment information is presented on the interactive comment interface, and after a trigger operation is performed on a rich-media comment, the floating layer is enabled to emerge on the interactive comment interface, and the detail content of the rich-media comment information is presented in the floating layer. All interactive comment information does not need to be presented in a content stream, so as to reduce presentation space, and the detail content does not need to be viewed in a page skipping manner. Therefore, it is more convenient to view the detail content by using the floating layer.

In these example embodiments, the presentation module 1012 is further configured to present, on the interactive comment interface, the rich-media comment information carrying a detail content viewing control.

Further, the presentation module 1012 is further configured to present the rich-media comment information in a text link form on the interactive comment interface; or

the presentation module 1012 is further configured to present the rich-media comment information and a detail content viewing icon or button on the interactive comment interface.

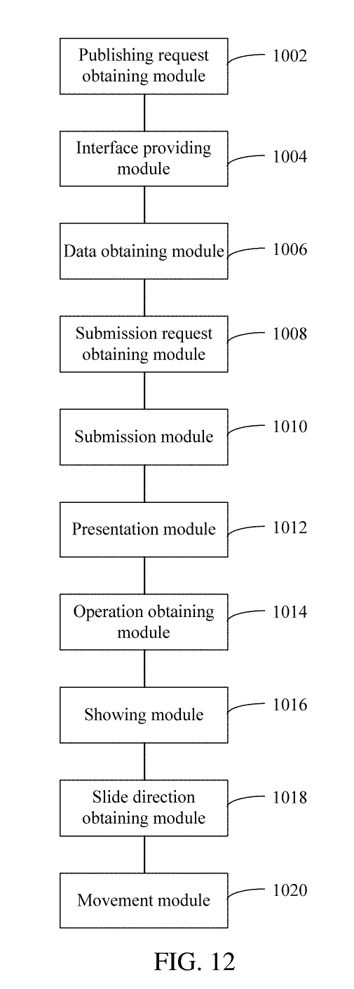

FIG. 12 is a structural block diagram of an interactive comment interaction apparatus according to these example embodiments. As shown in FIG. 12, in addition to a publishing request obtaining module 1002, an interface providing module 1004, a data obtaining module 1006, a submission request obtaining module 1008, a submission module 1010, a presentation module 1012, an operation obtaining module 1014, and a showing module 1016, the interactive comment interaction apparatus further includes a slide direction obtaining module 1018 and a movement module 1020.

The slide direction obtaining module 1018 is configured to obtain a slide operation direction for the detail content of the rich-media comment information in the floating layer after the floating layer is enabled to emerge on the interactive comment interface according to the trigger operation and the detail content of the rich-media comment information is presented in the floating layer.

The movement module 1020 is configured to correspondingly move the detail content of the rich-media comment information according to the slide operation direction.

Moreover, the movement module 1020 obtains a slide operation speed, and determines, according to the slide operation speed, a distance by which the detail content of the rich-media comment information is moved.

In these example embodiments, a slide operation distance and a slide operation time are obtained, and the slide operation speed is obtained through calculation according to the slide operation distance and the slide operation time. A mapping relationship between the slide operation speed and the distance by which the detail content is moved is obtained by collecting statistics. The movement distance is obtained according to the slide operation speed from the mapping relationship between the slide operation speed and the distance by which the detail content is moved.

In these example embodiments, a distance between two last points of a track formed by a slide operation and a consumed time are obtained, and a slide operation speed is obtained through calculation.

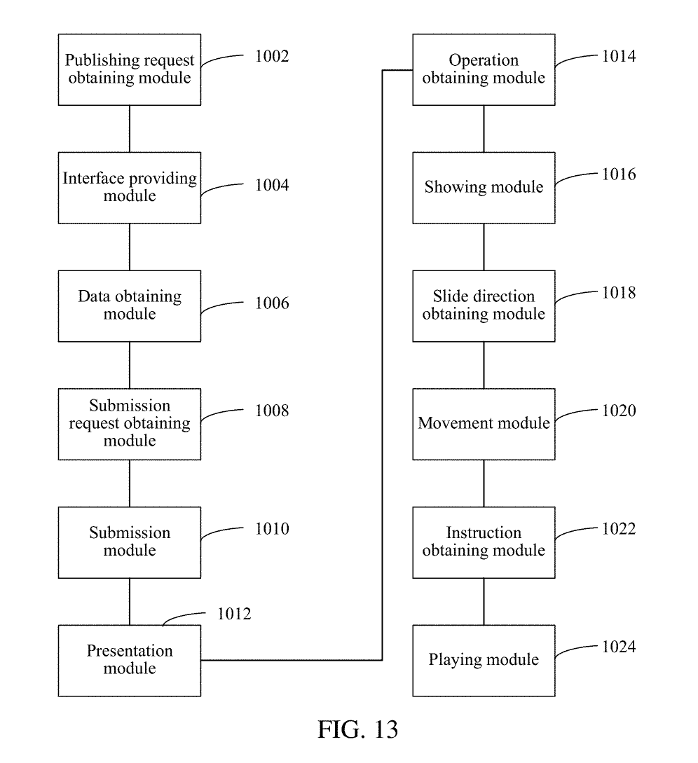

FIG. 13 is a structural block diagram of an interactive comment interaction apparatus according to example embodiments. As shown in FIG. 13, in addition to a publishing request obtaining module 1002, an interface providing module 1004, a data obtaining module 1006, a submission request obtaining module 1008, a submission module 1010, a presentation module 1012, an operation obtaining module 1014, a showing module 1016, a slide direction obtaining module 1018, and a movement module 1020, the interactive comment interaction apparatus further includes an instruction obtaining module 1022 and a playing module 1024.

The rich-media comment information includes one or more combinations of a speech, music, and a video.

The instruction obtaining module 1022 is configured to obtain a playing instruction.

The playing module 1024 is configured to play the one or more combinations of the speech, the music, and the video in the floating layer playing according to the playing instruction.

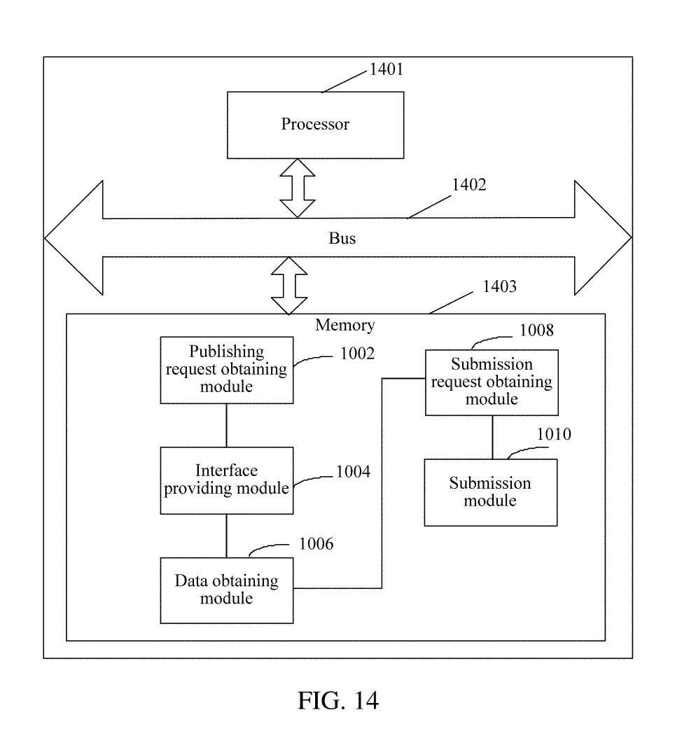

FIG. 14 is a structural block diagram of hardware of an interactive comment interaction apparatus according to another embodiment. The apparatus may include a processor 1401, a bus 1402, and a memory 1403. The processor 1401 and the memory 1403 are interconnected by using the bus 1402.

The memory 1403 stores a publishing request obtaining module 1002, an interface providing module 1004, a data obtaining module 1006, a submission request obtaining module 1008, and a submission module 1010. The memory 402 may further store a presentation module 1012, an operation obtaining module 1014, a showing module 1016, a slide direction obtaining module 1018, a movement module 1020, an instruction obtaining module 1022, and a playing module 1024 (not shown in the figure).

When the modules stored in the memory 1403 are executed by the processor 1401, operations performed by the modules are the same as those in the foregoing example embodiments.

A person of ordinary skill in the art may understand that all or some of the procedures of the methods of the foregoing example embodiments may be implemented by a computer program instructing relevant hardware. The program may be stored in a non-transitory computer readable storage medium. When the program is executed, the program may include the procedures of the example embodiments of the foregoing methods. The storage medium may be a magnetic disk, an optical disc, a read-only memory (ROM), or the like.

1. An interactive comment interaction method, the method performed by at least one computer processor and comprising:
obtaining a comment publishing request on an interactive comment interface;
providing a data input interface based the comment publishing request, the data input interface comprising a text input interface, a picture input interface, a music input interface, a speech input interface, and a video input interface;
obtaining one or more combinations of text, a picture, a speech, and a video that are input by using the data input interface, to form rich-media comment information;
obtaining a submission request for the rich-media comment information; and
submitting the rich-media comment information based on the submission request.

2. The method according to claim 1, further comprising:
presenting the rich-media comment information on the interactive comment interface;
obtaining a trigger operation for the rich-media comment information; and
enabling a floating layer to emerge on the interactive comment interface based on the trigger operation, and presenting detail content of the rich-media comment information in the floating layer.

3. The method according to claim 2, wherein the presenting the rich-media comment information on the interactive comment interface comprises:
presenting, on the interactive comment interface, the rich-media comment information carrying a detail content viewing control.

4. The method according to claim 3, wherein the step of presenting, on the interactive comment interface, the rich-media comment information carrying a detail content viewing control further comprising:
presenting the rich-media comment information in a text link form on the interactive comment interface; or
presenting the rich-media comment information and a detail content viewing icon or button on the interactive comment interface.

5. The method according to claim 2, the method further comprises:
obtaining a slide operation direction for the detail content of the rich-media comment information in the floating layer; and
correspondingly moving the detail content of the rich-media comment information according to the slide operation direction.

6. The method according to claim 2, wherein the rich-media comment information comprises one or more combinations of a speech, music, and a video; and the method further comprises:
obtaining a playing instruction; and
playing the one or more combinations of the speech, the music, and the video according to the playing instruction.

7. An interactive comment interaction apparatus, the apparatus comprising:
at least one memory configured to store computer program code;
at least one processor configured to access said memory and operate according to said computer program code, said computer program code including:
publishing request obtaining code configured to cause at least one of said at least one processor to obtain a comment publishing request on an interactive comment interface;
interface providing code configured to cause at least one of said at least one processor to provide a data input interface based on the comment publishing request, the data input interface comprising a text input interface, a picture input interface, a music input interface, a speech input interface, and a video input interface;
data obtaining code configured to cause at least one of said at least one processor to obtain one or more combinations of text, a picture, a speech, and a video that are input by using the data input interface, to form rich-media comment information;
submission request obtaining code configured to cause at least one of said at least one processor to obtain a submission request for the rich-media comment information; and
submission code configured to cause at least one of said at least one processor to submit the rich-media comment information according to the submission request.

8. The apparatus according to claim 7, further comprising:
presentation code configured to cause at least one of said at least one processor to present the rich-media comment information on the interactive comment interface after the rich-media comment information is submitted according to the submission request;
operation obtaining code configured to cause at least one of said at least one processor to obtain a trigger operation for the rich-media comment information; and
showing code configured to cause at least one of said at least one processor to enable a floating layer to emerge on the interactive comment interface based on the trigger operation, and present detail content of the rich-media comment information in the floating layer.

9. The apparatus according to claim 8, wherein the presentation code is further configured to cause at least one of said at least one processor to present, on the interactive comment interface, the rich-media comment information carrying a detail content viewing control.

10. The apparatus according to claim 9, wherein the presentation code is further configured to cause at least one of said at least one processor to present the rich-media comment information:
in a text link form on the interactive comment interface; or
with a detail content viewing icon or button on the interactive comment interface.

11. The apparatus according to claim 8, wherein the memory further comprises:
slide direction obtaining code configured to cause at least one of said at least one processor to obtain a slide operation direction for the detail content of the rich-media comment information in the floating layer after the floating layer is enabled to emerge on the interactive comment interface based on the trigger operation and the detail content of the rich-media comment information is presented in the floating layer; and
movement code configured to cause at least one of said at least one processor to correspondingly move the detail content of the rich-media comment information based on the slide operation direction.

12. The apparatus according to claim 8 further comprising:
instruction obtaining code configured to cause at least one of said at least one processor to obtain a playing instruction; and
playing code configured to cause at least one of said at least one processor to play the one or more combinations of the speech, the music, and the video in the floating layer playing based on the playing instruction.

13. A non-transitory computer-readable storage medium storing computer program code configured to cause a computer to perform the method according to claim 1.
